(19) United States
(12) Patent Application Publication
(10) Pub. No.: US 2008/0241400 A1
(43) Pub. Date: Oct. 2, 2008

(54) VACUUM ASSIST METHOD AND SYSTEM FOR REDUCING INTERMIXING OF LITHOGRAPHY LAYERS

(75) Inventors: Steven Scheer, Austin, TX (US); Kathleen Nafus, Leuven (BE)

Correspondence Address: WOOD, HERRON & EVANS, LLP (TOKYO ELECTRON), 2700 CAREW TOWER, 441 VINE STREET, CINCINNATI, OH, 45202, US

(73) Assignee: TOKYO ELECTRON LIMITED, Tokyo (JP)

(21) Appl. No.: 11/694,963

(22) Filed: Mar. 31, 2007

(51) Int. Cl. B05D 3/00

(52) U.S. Cl. 427/294; 118/50.1

(57) ABSTRACT

Embodiments of an apparatus and methods for curing a plurality of lithography layers while reducing the level of intermixing are generally described herein. Other embodiments may be described and claimed.

### FIELD OF THE INVENTION

The field of invention relates generally to semiconductor integrated circuit manufacturing and, more specifically but not exclusively, relates to a method and a system for curing lithography layers.

### BACKGROUND OF THE INVENTION

Conventional semiconductor processing involves the application and selective removal of a series of layers, such as photoresist layers or resist layers and anti-reflection layers, from a semiconductor substrate or wafer in a process known as lithography. Anti-reflection materials may be applied as a bottom coating layer, as a top coating layer, or alternatively as a bottom coating layer and a top coating layer. Top coating materials are applied as top anti-reflection coating (TARC) layers or films on the top of a resist layer to prevent the multiple interference of light that takes place within the resist layer during exposure. By minimizing the interference of light in a resist during exposure, the critical dimension (CD) variation of the geometrical features of a resist pattern that is caused by the variation in the thickness of the resist film can be minimized.

In lithography processes, TARC materials may be applied for use in the case of “dry” lithography and in “wet” or immersion lithography. Immersion lithography offers the potential to extend the use of optical lithography to print smaller features in the resist. In immersion lithography, air is replaced by a liquid medium such as water between the lens and the wafer. Use of a medium with an index of refraction higher than air results in a greater numerical aperture (NA) and, therefore, allows printing of smaller features.

An important characteristic of a TARC film is the ability to serve as a barrier between the underlying resist and the exposure medium, such as ultrapure water. As a barrier, the TARC film prevents or minimizes the underlying resist from leaching into the exposure medium and also prevents or minimizes the permeation of the exposure medium into the resist film. In addition, the TARC film is designed to be largely transparent to the energy used for exposure of the resist, thereby transferring most of the energy during the expose step to the underlying resist without absorbing a significant amount of the energy. The TARC material must also be effectively insoluble to the exposure medium to avoid contamination of the exposure medium or fouling of the lens.

Application of the TARC material typically requires the removal of one or more solvents from the TARC material using an elevated temperature bake step. The interface between the TARC film and the underlying resist may be well defined prior to the bake step, but may degrade during the bake step thereby creating an intermediate layer comprised of a mixture of resist and TARC material. The same phenomena may occur between the resist and an underlying BARC layer. The intermediate layer is caused due to the affinity between the TARC or BARC and resist polymer materials. The intermediate layer formed from the mixture of polymers may be less soluble to subsequent develop processes than the TARC and resist layers. The reduction in solubility may lead to regions of polymer material left un-removed by a develop process, leading to defects in the patterned resist.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 is a diagram of a coating/developing system.

FIG. 2 is a top view of one embodiment of a heat treatment apparatus for use in the coating/developing system of FIG. 1.

FIG. 3 is a cross-sectional side view of the heat treatment apparatus of FIG. 2 from the perspective of a wafer handler capable of disposing and removing wafers from the process chamber housing the heat treatment apparatus.

FIG. 4 is an illustration of a hotplate of the heat treatment apparatus in FIG. 2 in accordance with an embodiment of the invention.

FIG. 5 is a partial side view of a substrate with a plurality of lithography layers formed on the substrate.

FIG. 6 is a flowchart of an embodiment of a fabrication process used to cure a plurality of lithography layers with minimal intermixing between the layers.

FIG. 7 is a flowchart of another embodiment of a fabrication process used to cure a plurality of lithography layers with minimal intermixing between the layers.

### DETAILED DESCRIPTION

An apparatus and method for curing a plurality of lithography layers with minimal intermixing between the lithography layers is disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

There is a general need for decreasing the process time for curing a series of lithography layers while reducing the level of intermixing between the processable materials in the lithography layers. By reducing the level of intermixing between the processable materials in the lithography layers, the level of related defects due to incomplete development of the lithography layers may also be reduced. One embodiment of a method of curing a plurality of lithography layers on a substrate may comprise disposing the substrate, with a resist layer formed on a bottom anti-reflection coating (BARC) layer on the substrate, in a process chamber at a first pressure. The substrate is heated to release a volatile solvent or other volatile substance. The process chamber is evacuated to a second pressure to reduce intermixing of the resist layer and the bottom anti-reflection coating layer. The process chamber is vented.

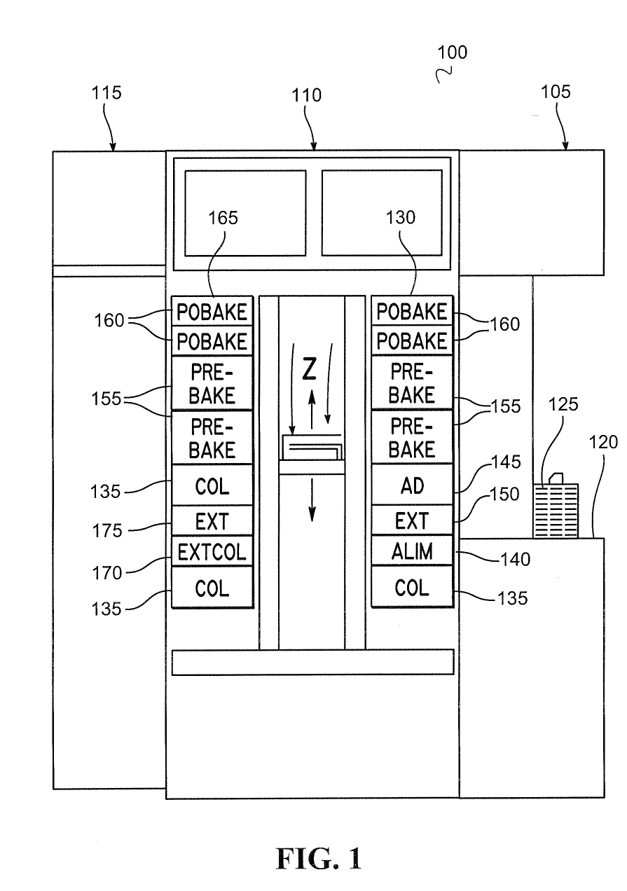

Now turning to the illustration in FIG. 1, one embodiment of a thermal or coating/developing system 100 has a load/unload section 105, a process section 110, and an interface section 115. In this embodiment, the load/unload section 105 has a cassette table 120 on which cassettes 125 each storing a plurality of semiconductor substrates for each, are loaded and unloaded from the system 100. The process section 110 has various single substrate processing units for processing substrates sequentially one by one. The interface section 115 is interposed between the process section 110 and a light-exposure apparatus, such as a stepper or step and scan lithography tool (not shown).

According to the embodiment illustrated in FIG. 1, a first process unit group 130 has a cooling unit (COL) 135, an alignment unit (ALIM) 140, an adhesion unit (AD) 145, an extension unit (EXT) 150, two prebaking units (PREBAKE) 155, and two postbaking units (POBAKE) 160 stacked sequentially from the bottom. Similarly, the second process unit group 165 has a cooling unit (COL) 135, an extension-cooling unit (EXTCOL) 170, an extension unit (EXT) 175, another cooling unit (COL) 135, two prebaking units (PREBAKE) 155 and two postbaking units (POBAKE) 160.

As described, the cooling unit (COL) 135 and the extension cooling unit (EXTCOL) 170 may be operated at low processing temperatures and arranged at lower stages, and the prebaking unit (PREBAKE) 155, the postbaking unit (POBAKE) 160 and the adhesion unit (AD) 145 are operated at high temperatures and arranged at the upper stages. With this arrangement, thermal interference between units may be reduced. Alternatively, these units may have different arrangements. The prebaking unit (PREBAKE) 155, the postbaking unit (POBAKE) 160, and the adhesion unit (AD) 145 each comprise a heat treatment apparatus in which substrates are heated to temperatures above room temperature at atmospheric, near atmospheric, reduced or sub-atmospheric pressures.

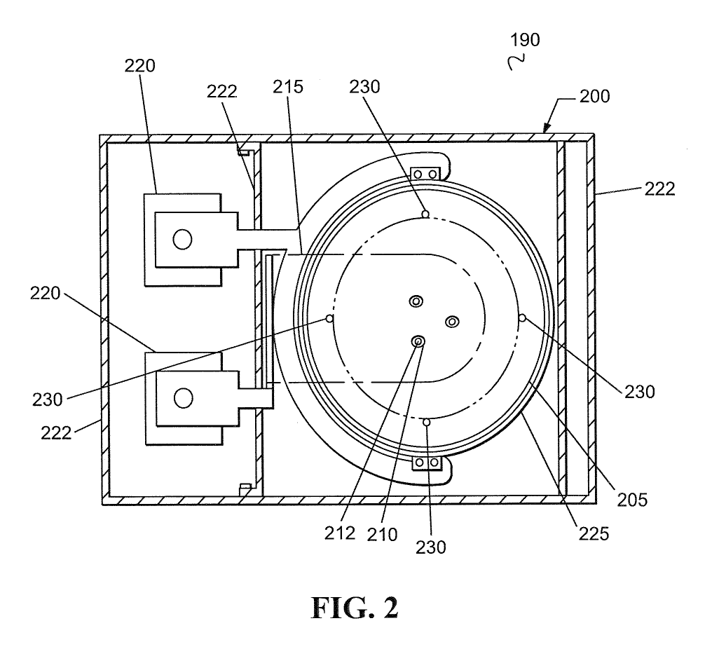

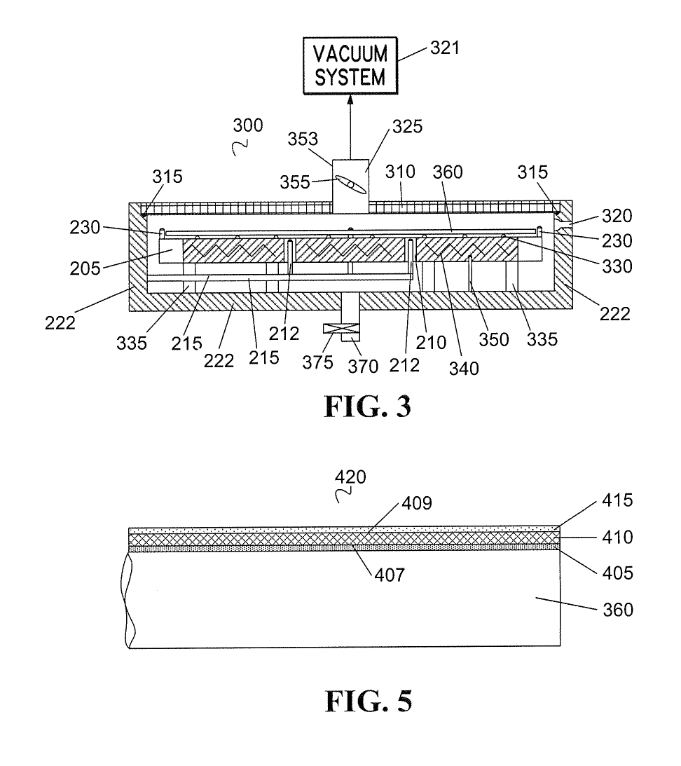

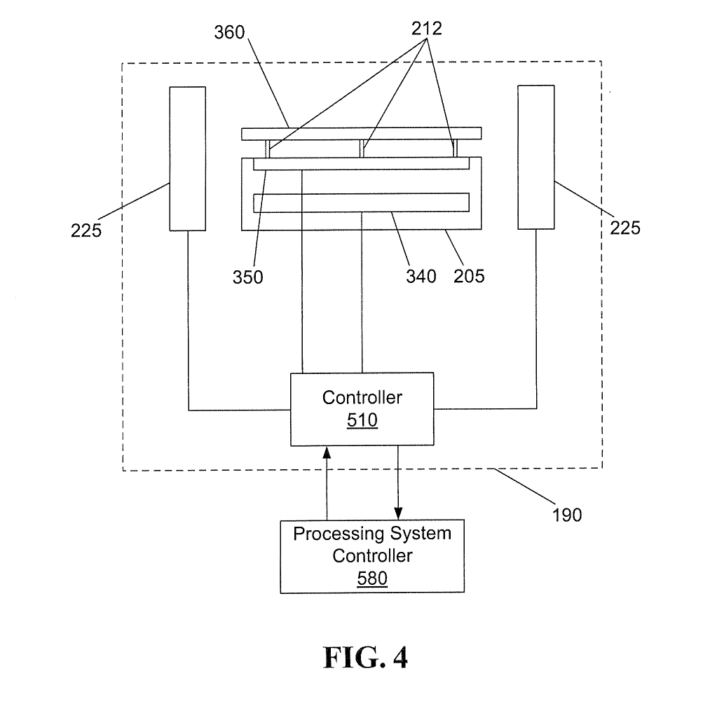

As illustrated in FIGS. 2, 3 and 4, a heat treatment apparatus 190 for use in the prebaking unit (PREBAKE) 155, the postbaking unit (POBAKE) 160, and/or the adhesion unit (AD) 145 comprises a process chamber 200 including a plurality of chamber walls 222, a heated substrate support in the form of a hotplate 205 in the representative embodiment, and one or more heating elements 340, such as resistance heaters embedded in the hotplate 205. In an alternate embodiment, the one or more heating elements 340 may be located proximate to, but not within, the hotplate 205. The hotplate 205 has a plurality of through-holes 210 and a plurality of lift pins 212 inserted into the through-holes 210. The substrate support pins 212 are connected to, and supported by, an arm 215, which is further connected to and supported by a rod of a vertical cylinder 220. The combined system may be referenced as an elevator. When the rod is actuated to protrude from the vertical cylinder 220, the substrate support pins 212 protrude from the hotplate 205, thereby elevating or lifting a substrate 360 (FIG. 3).

A plurality of projections 230 may be located on an upper surface of the hotplate 205 for accurately positioning the substrate 360. In addition, a plurality of smaller projections 330 (FIG. 3) may be formed on the upper surface of the hotplate 205. When the substrate 360 is mounted on the hotplate 205, top portions of these smaller projections contact the substrate 360, which produces a small gap between the substrate 360 and the hotplate 205, thereby preventing the lower surface of the substrate 360 from being strained and damaged.

A cooling device 225 is attached to the outer periphery of the hotplate 205. The cooling device 225 may comprise a ring-form shutter that is positioned at a place lower than the hotplate 205 at non-operation time, whereas, at an operation time, the ring-form shutter is lifted up to a position higher than the hotplate 205 and between the hotplate 205 and a cover (not shown). When the ring-form shutter comprising cooling device 225 is lifted up, a cooling gas, such as nitrogen gas or air, is exhausted from one or more air holes and, thereby, provided to one or more surfaces of the hotplate 205. The cooling device 225 can communicate with a gas supply source (not shown) at the upstream. A person having ordinary skill in the art will appreciate that the cooling device 225 may have a configuration that differs from the ring-form shutter shown in the representative embodiment. The cooling device 225 is used to quickly drop the temperature of the substrate 360 after processing using the hotplate 205, but while the substrate 360 is supported on the hotplate 205 waiting to be picked up and moved to the next processing stage.

The hotplate 205 is supported by a plurality of hotplate supports 335 and is fixed relative to the substrate support pins 212. The hotplate 205 is heated, at least in part the heating elements 340 to provide one or more zones of heating to the substrate 360. The hotplate 205 supplied a multi-zone heating chuck that supports and heats the substrate 360 if multiple zones of heating are present. The process chamber 300 is capped with a lid 310 and sealed at least in part using an elastomer seal 315. A vapor or gas pressure within the process chamber 300 is monitored through a pressure port 320 using a device such as a Bourdon gauge, a thermocouple gauge, a Pirani gauge, a cold cathode gauge, an ionization gauge, or a capacitance manometer.

The process chamber 300 may be evacuated through one or more exhaust ports 325 to a pressure between about 1 kPa (7.5 Torr) and about 101 kPa (758 Torr) using a vacuum system 323 that includes a vacuum pump, such as a ring compressor or a roughing pump like a venturi pump, a mechanical pump, or a booster/blower. The pressure within the process chamber 300 may be moderated using a throttle valve 355 in a vacuum line 353 coupling the vacuum system 323 with the environment inside process chamber 300. The throttle valve 355 may be adjusted to regulate the conductance through the vacuum line 353 and, thereby, regulate the effective pumping speed of the vacuum system 323. The exhaust port 325 (FIG. 3) is located on the top of the process chamber 300, though the embodiment is not so limited. Alternatively, one or more exhaust ports may be located on the lid 310 and/or one or more chamber walls 222. The process chamber 300 may be vented through one or more vent ports 370 to atmospheric or substantially near atmospheric pressure. Each vent port 370 to the process chamber 300 may be opened and closed using a valve 375 such as a gate valve, a ball valve, or a throttle valve, though the embodiment is not so limited.

Hotplate 205 may have a circular shape and may comprise a number of segments. One or more of the heating elements 340 may be positioned within each segment of the hotplate 205. In an alternative embodiment, hotplate 205 may incorporate one or more cooling elements and/or one or more combined heating/cooling elements rather than just heating elements.

Hotplate 205 may also include a sensor 350, which may be a physical sensor and/or a virtual sensor. The sensor 350 may comprise a temperature sensor, such as a thermocouple, a radiation type temperature sensor, a thermistor, or an optical temperature probe, used to monitor a temperature of the hotplate 205. Alternatively, sensor 350 may comprise a plurality of individual sensor elements. For example, sensor 350 may comprise a temperature sensor having multiple sensor elements and each individual sensor element may be located in one segment of the hotplate 205. In addition, sensor 350 may include at least one pressure sensor. A controller 510 is electrically coupled with the one or more heating elements 340 and sensor 350. Various types of physical temperature sensors 350 may be used. Other physical sensors 350 include contact-type sensors and non-contact sensors.

Heat treatment apparatus 190 and, in particular, controller 510 may be electrically coupled with a processing system controller 580 that is capable of transferring pattern parameter data, process history, and process flow information to and from the heat treatment apparatus 190. Pattern parameter data may include optical digital profile (ODP) data, such as critical dimension (CD) data, profile data, and uniformity data, and optical data, such as refractive index (n) data and extinction coefficient (k) data. For example, CD data measurements collected by the metrology tool may include transistor gate widths, via or plug diameters, recessed line widths, or three-dimensional semiconductor bodies, though the embodiment is not so limited.

Process history may comprise a collection of data such as process recipes, tool and chamber identifications, status, event reporting, in-line parametric data, defectivity maps, as well as other information specific to the manufacturing steps used to fabricate a semiconductor device, liquid crystal display, or a micro-electromechanical system. A process flow may comprise process tool, process chamber, and recipe information for a semiconductor device, liquid crystal display, or a micro-electromechanical system on one of the substrates 360 to be processed.

Processing system controller 580 may comprise a microprocessor, a memory (e.g., volatile and/or non-volatile memory), and a digital input/output port for transmitting and receiving data. A program stored in the memory may be used to control the aforementioned components of the heat treatment apparatus 190 according to a process recipe. Processing system controller 580 may be configured to analyze the process data, to compare the process data with target process data, and to use the comparison to change a process and/or control the processing system components. Alternatively, the processing system controller 580 may be configured to analyze the process data, to compare the process data with historical process data, and to use the comparison to predict and/or establish an endpoint.

Processing system controller 580 can also control the flow rate of gas flowing from the cooling device 225. In an alternative embodiment, heat treatment apparatus 190 may include a monitoring device (not shown) that, for example, permits optical monitoring of the substrate 360.

FIG. 5 is a partial side view of a wafer 420 comprising substrate 360 and one or more bottom anti reflection coating (BARC) layers 405, one or more resist layers 410, and one or more top anti-reflection coating (TARC) layers 415 layers formed as photolithographic layers on substrate 360. BARC layer 405 is contiguous with a lower surface 407 of the resist layer 410 and TARC layer 415 is contiguous with an upper surface 409 of the resist layer 410. Each of the layers 405, 410, 415 contains a processable material, as further described hereinbelow. The BARC layer 405 may be applied to a top surface of the substrate 360, followed by application of the resist layer 410 and, optionally, the TARC layer 415 on upper surface 409. The resist layer 410 may be applied to the top surface of the substrate 360, followed by application of the TARC layer 415.

The BARC layer 405, which is formed using an anti-reflection coating material such as DUV 112, ARC®29A, or DUV42P from Brewer Science, may be applied and selectively removed by a wet-patterning process using a coating/developing system 100, though the embodiment is not so limited. In another embodiment, a hard mask BARC (not shown) similar to BARC layer 405 may be formed by a dry-patterning process comprising coating/developing system 100 (FIG. 1) in combination with a dry etch tool (not shown). In one embodiment, a thickness of the BARC layer 405 may be between about 50 nanometers and about 100 nanometers. In another embodiment, the thickness of the BARC layer 405 may be between about 20 nanometers and about 50 nanometers. In an alternative embodiment, the thickness of the BARC layer 405 may be between about 100 nanometers and about 300 nanometers.

The BARC layer 405 is coated with a resist layer 410. The resist layer 410 may be a negative resist, a positive resist, or a dual-tone (positive-negative) resist. The resist material comprising resist layer 410 may have several chief components including a polymer, a sensitizer, a volatile solvent, and other additives. In a negative resist, the chemical bonds are cross-linked after exposure to light, allowing a subsequent developer step to wash away the unexposed areas. In a positive resist, chemical bonds are broken after exposure to light, allowing the developer to wash away the exposed areas. A dual-tone resist can share characteristics of both positive and negative type resists. In one embodiment, the resist layer 410 is a photoresist, or a light-sensitive coating that is temporarily applied to a substrate to allow the transfer of an optical image from a mask to the surface of the substrate. The resist layer 410 is applied to the surface of the substrate 360 using a spin-on process, soft-baked, exposed, post-exposure baked, developed, and hard-baked prior to subsequent processing. The resist in resist layer 410 may be cured using a heated surface or substance to evolve a volatile solvent from the resist and to strengthen the resist for subsequent processing.

Alternatively, the resist contained in resist layer 410 may be a chemically amplified (CA) positive or negative resist where a catalytic species generated by irradiation during exposure induces a cascade of subsequent chemical transformations. The heated bake process may be applied to activate an acid in a CA resist in a reaction that alters the solubility properties of the film in the irradiated areas, as in the case of a positive CA resist.

The resist layer 410 may be patterned or un-patterned and the TARC layer 415 may be applied over the resist layer 410. The TARC layer 415 is an anti-reflection and barrier layer, which may be used in immersion lithography applications. The TARC layer 415, which is formed from anti-reflection coating material, may prevent the resist layer 410 from contaminating the immersion fluid. The TARC layer 415 may also be used to prevent the immersion liquid from contacting and modifying the properties of the resist layer 410.

In one embodiment, the BARC layer 405 and the TARC layer 415 are in direct contact with the resist layer 410. The processable material in BARC layer 405, the processable material in resist layer 410, the processable material in the TARC layer 415, or any combination of the processable materials in layers 405, 410, 415 may contain one or more volatile solvents, such as 1-methoxy-2-propanol acetate, 1-methoxy-2-propanol, 2-ethoxyethyl acetate, cyclopentanone, N-methylpyrrolidone, dimethyl sulfoxide, 1-butanol, methanol, ethanol, 1-propanol, ethylene glycol, 1,2-butanediol, 1,3-butanediol, 1,4-butanediol, 1,2-propanediol, 1 methyl-2-butanol, 1-pentanol, 2-pentanol, 3-pentanol, 1-hexanol, 2-hexanol, 3-hexanol, 1-heptanol, 2-heptanol, 3-heptanol, 4-heptanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-2-pentanol, 2,4-dimethyl-3-pentanol, 3-ethyl-2-pentanol, 1-methylcyclopentanyl, 2-methyl-1-hexanol, 2-methyl-2-hexanol, 2-methyl-3-hexanol, 3-methyl-3-hexanol, 4-methyl-3-hexanol, 5-methyl-1-hexanol, 5-methyl-2-hexanol, 5-methyl-3-hexanol, 4-methylcyclohexanol, 1,3-propanediol, or mixtures of two or more of these solvents.

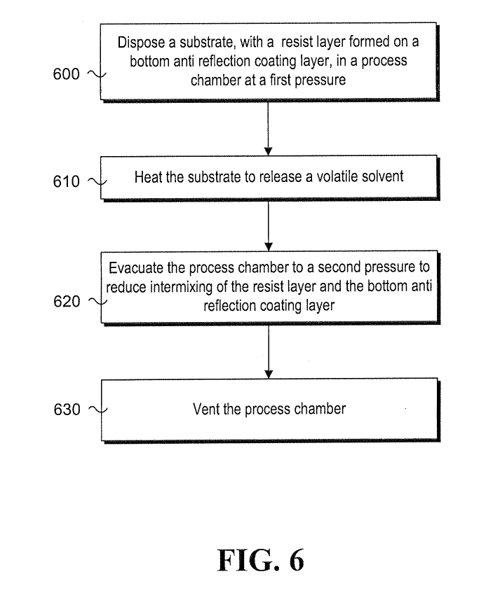

FIG. 6 is a flowchart describing one embodiment of a fabrication process used to cure a plurality of lithography layers with reduced intermixing of the lithography layers. In block 600, the fabrication process may be initiated by disposing substrate 360, with resist layer 410 (FIG. 5) formed on BARC layer 405 (FIG. 5), in process chamber 200 at a first pressure. The first pressure may be at or near atmospheric pressure in a range between about 740 Torr (about 99 kPa) and about 770 Torr (about 103 kPa). The BARC layer 405 may have been formed without a heat treatment cure prior to forming the resist layer 410. In an alternative embodiment, a heat treatment cure may be applied using an apparatus such as a PREBAKE 155 prior to forming the resist layer 410.

In block 610, the substrate 360 along with the BARC layer 405 and the resist layer 410 are heated to release a volatile substance like solvent, which outgases from the layers 405, 410 into the reduced pressure environment inside the process chamber 200. A temperature of the substrate 360, the BARC layer 405, and the resist layer 410 exposed to the heat treatment cure may range between about 20° C. and about 100° C. in one embodiment. In another embodiment, the temperature of the substrate 360 and lithography layers exposed to the heat treatment cure may range between about 70° C. and 140° C. A process time for heat treatment cure may range between about 20 seconds and about 60 seconds in one embodiment. In another embodiment, the process time for heat treatment cure may range between about 60 seconds and about 90 seconds.

In block 620, the process chamber 300 is evacuated to a second pressure lower than the first pressure and effective to reduce intermixing of the heated resist layer 410 and BARC layer 405. The reduction in the intermixing operates to reduce the number and/or size of lithography defects in subsequent processing, such as a development step. In certain specific embodiments, the second pressure may be between about 1 kPa (7.5 Torr) and about 101 kPa (758 Torr). The reduction in the intermixing between the layers 405, 410 proximate to lower surface 407 is believed to be enabled because of a reduction in heat treatment cure temperature and/or a reduction in heat treatment cure process time, as compared to conventional heat treatment cure processes. A reduction in total pressure in the process chamber 200 may allow the volatile solvents in the resist layer 410 and the BARC layer 405 to be expelled or released from the layers 405, 410 more readily at the lower total pressure in comparison with conventional heat treatment curing processes during which the total pressure of the gas mixture in the process chamber 200 would be significantly higher. The throttle valve 355 may be throttled to maintain the second pressure at a constant value or other regulated values. In block 630, the process chamber 200 is vented to allow the substrate 360 with lithography layers to be accessed by a wafer handler (not shown) for removal from the process chamber 200.

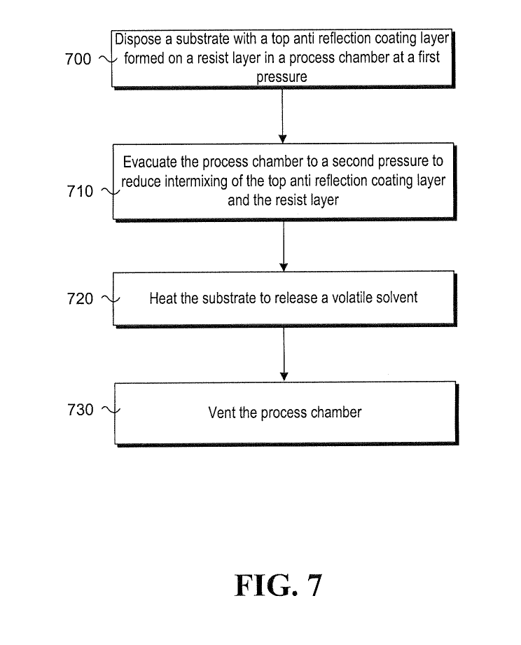

FIG. 7 is a flowchart describing another embodiment of a fabrication process used to cure a plurality of lithography layers with reduced intermixing of the lithography layers. The process may be initiated (block 700) by disposing substrate 360, with a TARC layer 415 (FIG. 5) formed on resist layer 410 (FIG. 5), in process chamber 200 at a first pressure. The first pressure may be at, or near, atmospheric pressure in a pressure range between about 740 Torr (about 99 kPa) and about 770 Torr (about 103 kPa).

In block 710, the process chamber 200 is evacuated to a second pressure lower than the first pressure and effective to reduce intermixing of the resist layer 410 and the TARC layer 415. The reduced intermixing reduces the number and/or size of lithography defects in subsequent processing, such as a development step. In certain specific embodiments, the second pressure may be between about 1 kPa (7.5 Torr) and about 101 kPa (758 Torr). The reduction of intermixing between the layers 410, 415 proximate to the upper surface 409 is enabled due to a reduction in heat treatment cure temperature and/or a reduction in heat treatment cure process time, as compared with conventional heat treatment curing processes. A reduction in total pressure in the process chamber 200 may allow the volatile solvents in the layers 410, 415 to be expelled or released from the layers 410, 415 more readily at a lower total pressure in comparison with conventional heat treatment curing processes during which the total pressure of the gas mixture in the process chamber 200 would be higher.

In block 720, the substrate 360 along with the resist layer 410 and the TARC layer 415 are heated to release a volatile substance like solvent, which outgases from the layers 405, 410 into the reduced pressure environment inside the process chamber 200. A temperature of the substrate 360 and layers 410, 415 exposed to the heat treatment cure may range between about 20° C. and about 100° C. in one embodiment. In another embodiment, the temperature of the substrate 360 and layers 410, 415 exposed to the heat treatment cure may range between 70° C. and 140° C. A process time for heat treatment cure may range between about 20 seconds and about 60 seconds in one embodiment. In another embodiment, the process time for heat treatment cure may range between about 60 seconds and about 90 seconds. The throttle valve 355 may be throttled to maintain the second pressure at a constant value. In block 730, the process chamber 300 is vented to allow the substrate 360 with layers 410, 415 to be accessed. The substrate 360 may be cooled on a chill plate after the heating.

A plurality of embodiments of curing a plurality of lithography layers while reducing the level of intermixing between the individual lithography layers has been described. The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side (or active surface) of a substrate or integrated circuit is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations.

Persons skilled in the relevant art can appreciate that many modifications and variations are possible in light of the above teaching. Persons skilled in the art will recognize various equivalent combinations and substitutions for various components shown in the Figures. It is therefore intended that the scope of the invention be limited not by this detailed description, but rather by the claims appended hereto.

What is claimed is:

1. A method of curing a plurality of lithography layers on a substrate, the lithography layers including a first layer of a first processable material and a second layer of a second processable material that is contiguous with the first layer, the method comprising:
placing the substrate in a process chamber at a first pressure;
heating the substrate in the process chamber; and
evacuating the process chamber to a second pressure lower than the first pressure in order to reduce intermixing between the first and second layers.

2. The method of claim 1 wherein the first processable material contains an anti-reflection coating material the second processable material contains a resist material, and further comprising:
depositing the anti-reflection coating material in the first layer on a top surface of the substrate; and
depositing the resist material in the second layer on the anti-reflection coating material in the second layer.

3. The method of claim 1 wherein the first processable material contains an anti-reflection coating material and the second processable material contains a resist material, and further comprising:
depositing the resist material in the second layer on a top surface of the substrate; and
depositing the anti-reflection coating material in the first layer on the resist material in the second layer.

4. The method of claim 1 wherein the lithography layers further include a third layer of a third processable material, the first and third processable materials contain an anti-reflection coating material, and the second processable material contains a resist material, and further comprising:
depositing the anti-reflection coating material in the first layer on a top surface of the substrate;
depositing the resist material in the second layer on the anti-reflection coating material in the first layer; and
depositing the anti-reflection coating material in the third layer on the resist material in the second layer.

5. The method of claim 1 wherein the first pressure is between about 99 kPa and about 103 kPa.

6. The method of claim 1 wherein the second pressure is between about 1 kPa and about 101 kPa.

7. The method of claim 1 wherein at least one of the first processable material or the second processable material contains a volatile substance, and heating the substrate in the process chamber further comprises:
releasing the volatile substance from the at least one of the first processable material or the second processable material upon heating to a process temperature for evacuation from the process chamber.

8. The method of claim 7 wherein evacuating the process chamber further comprises:
continuously evacuating the released volatile substance from the process chamber to maintain the second pressure.

9. The method of claim 8 wherein continuously evacuating the released volatile substance further comprises:
regulating the second pressure in the process chamber while the substrate is heated.

10. The method of claim 9 further comprising:
throttling a valve in a vacuum line coupling the process chamber with a vacuum system to maintain the second pressure at a constant value.

11. The method of claim 1 further comprising:
cooling the substrate on a chill plate after the substrate is heated.

12. The method of claim 1 wherein heating the substrate in the process chamber further comprises:
heating the substrate to a process temperature effective to cure at least one of the first processable material or the second processable material.

13. A system to reduce intermixing of lithography layers on a substrate, the system comprising:
a process chamber having a port;
a vacuum system coupled with the port, the vacuum system configured to evacuate the process chamber through the port to a pressure effective to reduce intermixing of the plurality of lithography layers during curing;
a substrate support in the process chamber, the substrate support configured to support the substrate, and the substrate support including a heating element; and
a controller electrically coupled with the heating element, the controller configured to control the operation of the heating element for heating the plurality of lithography layers to a process temperature effective to cure at least one of the lithography layers.

14. The system of claim 13 wherein the substrate support is a multi-zone heating chuck.

15. The system of claim 13 wherein the vacuum system comprises a mechanical pump configured to evacuate the process chamber to maintain the pressure between about 1 kPa and about 101 kPa.

16. The system of claim 13 wherein the vacuum system comprises a vacuum pump, a vacuum line coupling the vacuum pump with the process chamber, and a throttle valve in the vacuum line that is adjustable for regulating evacuation of the process chamber through the vacuum line to the vacuum pump.
